(19) United States
(12) Patent Application Publication
(10) Pub. No.: US 2022/0223889 A1
(43) Pub. Date: Jul. 14, 2022

(54) INFORMATION PROCESSING DEVICE, INFORMATION PROCESSING SYSTEM, AND PROGRAM

(71) Applicant: TOYOTA JIDOSHA KABUSHIKI KAISHA, Toyota-shi (JP)

(72) Inventors: Masato EHARA, Gotemba-shi (JP); Kazuhiro SHIMIZU, Sunto-gun (JP); Satoshi TANABE, Mishima-shi (JP); Nanae TAKADA, Susono-shi (JP); Naohiro SEO, Sunto-gun (JP)

(73) Assignee: TOYOTA JIDOSHA KABUSHIKI KAISHA, Toyota-shi (JP)

(21) Appl. No.: 17/456,974

(22) Filed: Nov. 30, 2021

(30) Foreign Application Priority Data
Jan. 14, 2021 (JP) 2021-004155

(51) Int. Cl. H01M 8/04492; H01M 8/04537; G01C 21/34; G01C 21/36; B60W 20/20

(52) U.S. Cl. CPC H01M 8/04492; H01M 8/04649; B60W 20/20; G01C 21/3605; G01C 21/3469

(57) ABSTRACT

An information processing device includes a processor that: acquires movement information related to a movement of a moving body from the moving body including a fuel cell using hydrogen fuel as a power source of the moving body, a storage unit for storing hot water discharged from the fuel cell, and a tub for using the hot water discharged from the storage unit; acquires destination information related to a destination of the moving body from the moving body or a terminal of a user who uses the moving body; and acquires set values of a water amount and a water temperature of the hot water stored in the storage unit from the moving body, generates schedule information related to traveling of the moving body based on the movement information, the destination information, and the set values, and outputs the schedule information to the moving body.

### CROSS-REFERENCE TO RELATED APPLICATION

This application claims priority to Japanese Patent Application No. 2021-004155 filed on Jan. 14, 2021, incorporated herein by reference in its entirety.

### BACKGROUND

### 1. Technical Field

The present disclosure relates to an information processing device, an information processing system, and a program.

### 2. Description of Related Art

Japanese Unexamined Patent Application Publication No. 11-191421 (JP 11-191421 A) discloses a polymer electrolyte fuel cell having water supply means for supplying water to the upper surface side of the polymer electrolyte fuel cell and a plurality of water discharging means dispersedly provided on the lower surface side of the polymer electrolyte fuel cell for discharging residual water that has been supplied from the water supply means but has not been consumed and water generated by a chemical reaction to the outside of the polymer electrolyte fuel cell.

### SUMMARY

However, in the technique described in JP 11-191421 A, the water discharged from the fuel cell (FC) is discharged to the outside and is not effectively used. Similarly, in the fuel cell vehicle, the water discharged from the fuel cell vehicle (FCV) is also discharged to the outside and is not effectively used. Therefore, there has been a demand for the development of a technique that can effectively use the water discharged from the fuel cell.

The present disclosure has been made in view of the above, and an object thereof is to provide an information processing device, an information processing system, and a program capable of effectively using water discharged from a fuel cell.

An information processing device according to the present disclosure includes a processor that: acquires movement information related to a movement of a moving body from the moving body including a fuel cell using hydrogen fuel as a power source of the moving body, a storage unit for storing hot water discharged from the fuel cell, and a tub for using the hot water discharged from the storage unit; acquires destination information related to a destination of the moving body from the moving body or a terminal of a user who uses the moving body; and acquires set values of a water amount and a water temperature of the hot water stored in the storage unit from the moving body, generates schedule information related to traveling of the moving body based on the movement information, the destination information, and the set values, and outputs the schedule information to the moving body.

An information processing system according to the present disclosure includes: a first device including a fuel cell using hydrogen fuel as a power source for movement, a storage unit for storing hot water discharged from the fuel cell, a tub for using the hot water discharged from the storage unit, and a first processor for outputting movement information related to the movement; and a second device including a second processor that acquires destination information related to a destination of the first device from the first device or a terminal of a user, that acquires set values of a water amount and a water temperature of the hot water stored in the storage unit from the first device, that generates schedule information related to the movement based on the movement information, the destination information, and the set values, and that outputs the schedule information.

A program according to the present disclosure causes a processor to execute: acquisition of movement information related to a movement of a moving body from the moving body including a fuel cell using hydrogen fuel as a power source of the moving body, a storage unit for storing hot water discharged from the fuel cell, and a tub for using the hot water discharged from the storage unit; acquisition of destination information related to a destination of the moving body from the moving body or a terminal of a user who uses the moving body; acquisition of set values of a water amount and a water temperature of the hot water stored in the storage unit from the moving body; and generation of schedule information related to traveling of the moving body based on the movement information, the destination information, and the set values, and output of the schedule information to the moving body.

According to the present disclosure, it is possible to effectively use the water discharged from the fuel cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an operation management system according to an embodiment;

FIG. 2 is a block diagram schematically showing a configuration of an operation management server according to the embodiment;

FIG. 3 is a block diagram schematically showing a configuration of a moving body according to the embodiment;

FIG. 4 is a block diagram schematically showing a configuration of a user terminal according to the embodiment; and

FIG. 5 is a flowchart illustrating an operation management method according to the embodiment.

### DETAILED DESCRIPTION OF EMBODIMENTS

Hereinafter, an embodiment of the present disclosure will be described below with reference to the drawings. In all the drawings of the following embodiment, the same or corresponding portions are designated by the same reference signs. The present disclosure is not limited to the embodiment described below.

In recent years, the development of fuel cell vehicles (FCVs), which are vehicles equipped with fuel cells, has been progressing. The fuel cell discharges water generated by a chemical reaction between hydrogen (H₂) and oxygen (O₂) as wastewater to the outside. However, the wastewater discharged from the fuel cell of the FCV has not been effectively utilized. Therefore, the present disclosers have devised a method of reusing the wastewater discharged from the FCV as hot water used for a movable bath or a foot bath, or hot water for drinking. In addition, when the hot water in the bath of the FCV has cooled, necessary traveling is performed and the fuel cell is used to generate electric power so that the hot water in the bath or foot bath can be adjusted to an appropriate temperature. Further, a user who gets on the FCV may adjust the water amount and the water temperature of the bath according to the arrival time by using the wastewater discharged when moving to the desired destination and the heat from the fuel cell. Hot water for drinking may be used in a store that provides coffee, tea, etc. to the outside, and hot water may be prepared by adjusting the water amount and the water temperature to the required values according to the business hours of the store. Furthermore, the FCV equipped with a hot water storage unit may generate schedule information including an operation plan based on demand information related to the demand for hot water and event information, predict free time, and be filled with hydrogen fuel when the free time is reached. The embodiment described below is based on the above proposal.

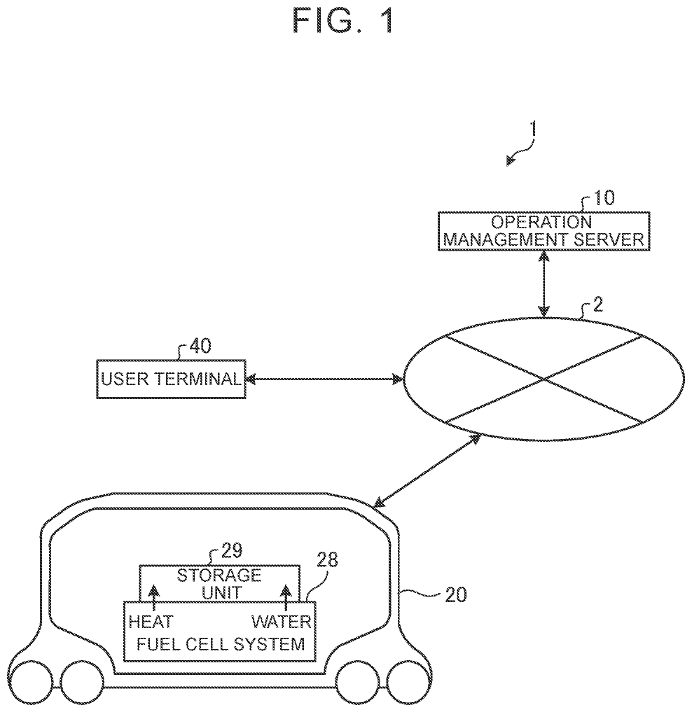

First, an operation management system to which an information processing device according to the embodiment of the present disclosure can be applied will be described. FIG. 1 is a schematic diagram showing an operation management system 1 according to the present embodiment. As shown in FIG. 1, the operation management system 1 according to the present embodiment includes an operation management server 10, an FC vehicle 20 having a fuel cell system 28 and a storage unit 29, and a user terminal 40, which can communicate with each other via a network 2. In the following description, information is transmitted and received between each component via the network 2. However, the description of transmission and reception via the network 2 will be omitted.

The network 2 is composed of, for example, the Internet network and a mobile phone network. The network 2 is, for example, a public communication network such as the Internet, and may include a telephone communication network such as a wide area network (WAN) and a mobile phone, and other communication networks such as a wireless communication network including WiFi (registered trademark).

Operation Management Server

The operation management server 10 serving as an operation management device for the FC vehicle 20 can manage the operation of the FC vehicle 20. In the present embodiment, various types of information such as vehicle information and movement information are supplied to the operation management server 10 from each FC vehicle 20 at a predetermined timing. The vehicle information includes, but is not necessarily limited to, vehicle identification information, sensor information, and position information. The sensor information includes, but is not necessarily limited to, energy remaining amount information related to the remaining energy amount such as the fuel remaining amount of hydrogen fuel and the battery state of charge (SOC) of the FC vehicle 20, and information measured by a sensor group 25 such as speed information and acceleration information. The movement information includes, but is not necessarily limited to, the position information and travel route information of the FC vehicle 20.

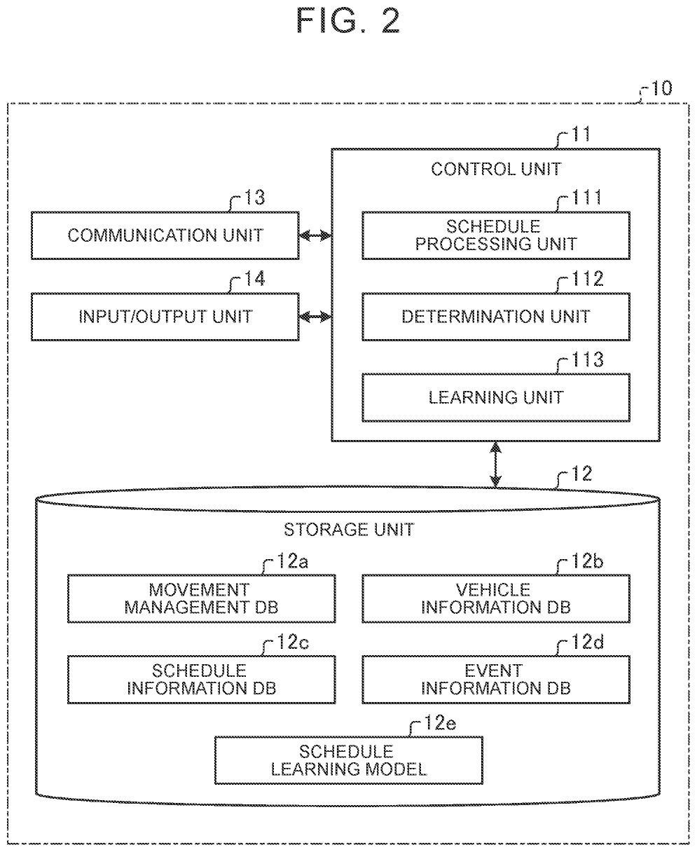

FIG. 2 is a block diagram schematically showing a configuration of the operation management server 10. As shown in FIG. 2, the operation management server 10 serving as a second device has a configuration of a general computer capable of communicating via the network 2. The operation management server 10 includes a control unit 11, a storage unit 12, a communication unit 13, and an input/output unit 14.

The control unit 11 serving as a second processor provided with hardware that manages the movement is specifically composed of a processor such as a central processing unit (CPU), a digital signal processor (DSP), and a field-programmable gate array (FPGA), and a main storage unit such as a random access memory (RAM) and a read-only memory (ROM).

The storage unit 12 includes, for example, a recording medium selected from an erasable programmable ROM (EPROM), a hard disk drive (HDD), and a removable medium. Examples of the removable medium include a disc recording medium such as a universal serial bus (USB) memory, a compact disc (CD), a digital versatile disc (DVD), and a Blu-ray (registered trademark) disc (BD). The storage unit 12 can store an operating system (OS), various programs, various tables, various databases, etc.

The control unit 11 loads the program stored in the storage unit 12 into the work area of the main storage unit and executes the program, and through the execution of the program, the control unit 11 can realize the functions of a schedule processing unit 111, a determination unit 112, and a learning unit 113.

The storage unit 12 stores a movement management database 12a, a vehicle information database 12b, a schedule information database 12c, and an event information database 12d in which various types of data are stored in a searchable manner. For these databases 12a to 12d, for example, a relational database (RDB) can be adopted. In the present embodiment, the database (DB) can be established when the program of the database management system (DBMS) executed by the processor manages the data stored in the storage unit 12.

The movement management database 12a stores the vehicle identification information of the vehicle information in association with other information such as the movement information in an updateable, deletable, and searchable manner. The vehicle information database 12b stores sensor information and the like of the FC vehicle 20 in association with the vehicle identification information in an updateable, deletable, and searchable manner. The schedule information database 12c stores the schedule information of the predetermined FC vehicle 20 in association with the vehicle identification information in an updateable, deletable, and searchable manner. The schedule information includes information related to the travel schedule, information of the power generation schedule related to the fuel cell system 28, and the like.

The event information database 12d stores event information such as information related to the landscape, information related to the weather, and information related to events in a predetermined area such as a smart city in an updateable, deletable, and searchable manner. The event information includes various types of information such as the position information of the destination where the FC vehicle 20 moves and time information including the event running time. The event information database 12d further stores demand information that is information on the types of the demand for the FC vehicle 20 in an updateable, deletable, and searchable manner. The demand information can be used when the FC vehicle 20 is configured as a store that provides services and products using a bathtub 30 and hot water. The demand information includes various types of information such as the position information of the opening point and the time information such as the business hours, which are expected to increase the sales, based on the vehicle search information by the user terminal 40 and the like.

The vehicle identification information assigned to each FC vehicle 20 is stored in the movement management database 12a in a searchable manner. The vehicle identification information includes various types of information for identifying the individual FC vehicles 20 from each other, and includes information necessary for accessing the operation management server 10 when transmitting information on the FC vehicle 20. The vehicle identification information is also transmitted when the FC vehicle 20 transmits various types of information. When the FC vehicle 20 transmits predetermined information such as the movement information together with the vehicle identification information to the operation management server 10, the control unit 11 stores the predetermined information in the corresponding databases 12a to 12d in a searchable manner and in association with the vehicle identification information.

A schedule learning model 12e may be stored in the storage unit 12. When the learning model serving as a program is used in the schedule processing unit 111, the schedule learning model 12e generated by machine learning by the learning unit 113 can be used as the program. That is, the learning unit 113 that is also a server learning unit performs machine learning based on an input/output data set serving as teacher data. For machine learning, for example, deep learning using a neural network or the like can be adopted. The learning unit 113 writes and stores the learned result in the schedule learning model 12e of the storage unit 12. The learning unit 113 can store the latest learning model at a predetermined timing in the schedule learning model 12e of the storage unit 12 separately from the neural network that is performing learning. When causing the schedule learning model 12e to store the latest learned model, updating may be performed in which the old learning model is deleted and the latest learning model is stored, or accumulation may be performed in which the latest learning model is stored while a part or all of the old learning model remains stored. The learning model can also be used for the determination unit 112. As a result, the control unit 11 can realize the functions of the schedule processing unit 111, the determination unit 112, and the learning unit 113 by the learning model.

The schedule learning model 12e uses information related to the FC vehicle 20, information related to the fuel cell system 28, information related to the storage unit 29, and information on the desired water temperature and water amount as input parameters. Specifically, the input parameters include information including the mileage and travel time of the FC vehicle 20, information on specifications such as the power generation ratio, heat generation ratio, and discharging flow rate of the fuel cell system 28, information on the capacity and heat transfer ratio of the storage unit 29, and information on the desired water temperature and water amount. In addition, the input parameters may include: information such as temperature, starting point, departure time, destination, arrival time, and mileage; power generation amount, heat generation amount, and discharging flow rate of the fuel cell system 28; and water storage amount, water temperature of the storage unit 29, and predicted values thereof. The schedule learning model 12e uses, as output parameters, navigation information including a travel route on which the FC vehicle 20 travels, and schedule information including a schedule of power generation, heat generation, and hydrogen fuel remaining amount of the fuel cell system 28. That is, the schedule learning model 12e can output the schedule information in which the water amount and water temperature of the hot water discharged from the fuel cell system 28 and stored in the storage unit 29 can be set to the desired water amount and water temperature when the FC vehicle 20 arrives at the destination. A rule-based inference engine may be used instead of the learning model.

The communication unit 13 is, for example, a local area network (LAN) interface board or a wireless communication circuit for wireless communication. The LAN interface board and the wireless communication circuit are connected to the network 2 such as the Internet, which is a public communication network. The communication unit 13 is connected to the network 2 and can communicate with the FC vehicle 20. The communication unit 13 can receive the vehicle identification information and the vehicle information unique to the FC vehicle 20 from each FC vehicle 20, and transmit various instruction signals or confirmation signals and various types of information such as the schedule information and the event information to each FC vehicle 20.

The input/output unit 14 may be composed of, for example, a touch panel display, a speaker microphone, and the like. The input/output unit 14 serving as an output unit is configured to notify predetermined information to the outside. That is, the input/output unit 14 is configured to be able to, due to control by the control unit 11, display characters, figures, and the like on a screen of a display such as a liquid crystal display, an organic electroluminescent (EL) display, or a plasma display, and output sound from a speaker. The input/output unit 14 includes a printer that outputs predetermined information by printing the information on printing paper or the like. Various types of information stored in the storage unit 12 can be confirmed, for example, on the display of the input-output unit 14 installed in a predetermined office or the like. The input/output unit 14 serving as an input unit is composed of, for example, a keyboard or a touch panel keyboard incorporated in the input/output unit 14 to detect a touch operation on the display panel, or a voice input device enabling the user to make a call to the outside. By inputting predetermined information from the input/output unit 14 of the operation management server 10, it is possible to remotely manage the movement of the FC vehicle 20, so that the movement of the FC vehicle 20 that is an autonomous driving vehicle capable of autonomous driving can be easily managed.

FC Vehicle

The FC vehicle 20 serving as a moving body that is a first device is a moving body that includes the fuel cell system 28, and that can use water (hot water or lukewarm hot water, hereinafter referred to as hot water) discharged from the fuel cell system 28, which is heated by heat from the fuel cell system 28. An autonomous driving vehicle configured to be able to autonomously travel according to an operation command given by the operation management server 10, a predetermined program, or the like can be adopted as the FC vehicle 20 serving as the moving body. The FC vehicle 20 may be a vehicle that travels by being driven by a driver.

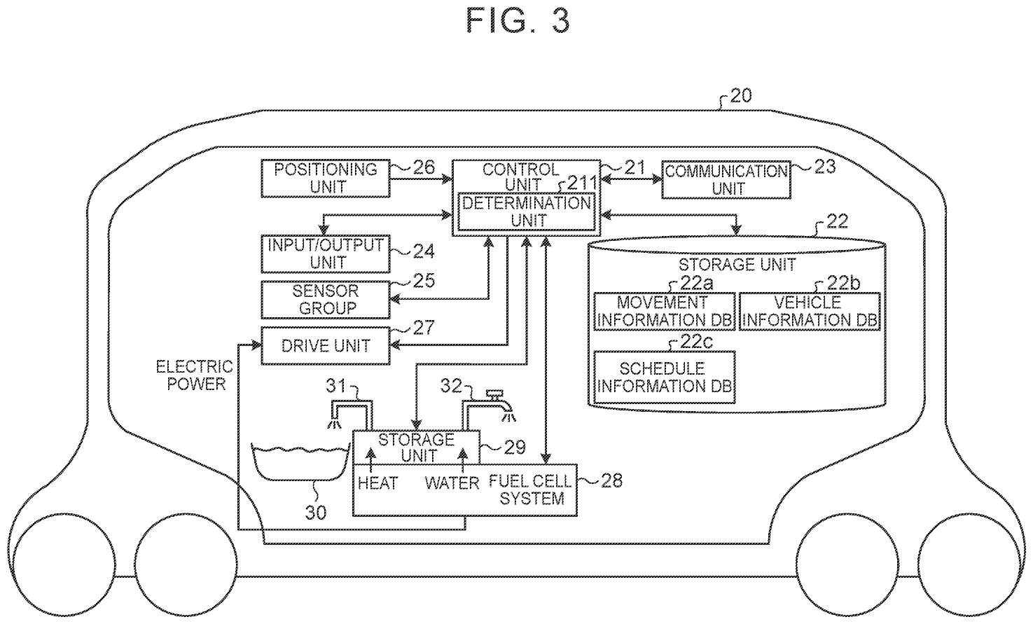

FIG. 3 is a block diagram schematically showing a configuration of the FC vehicle 20. As shown in FIG. 3, the FC vehicle 20 includes a control unit 21, a storage unit 22, a communication unit 23, an input/output unit 24, the sensor group 25, a positioning unit 26, a drive unit 27, the fuel cell system 28, the storage unit 29, and the bathtub 30. The control unit 21, the storage unit 22, the communication unit 23, and the input/output unit 24 have the same physical and functional configurations as the control unit 11, the storage unit 12, the communication unit 13, and the input/output unit 14, respectively.

The control unit 21 serving as a first processor provided with hardware comprehensively controls the operation of various components mounted on the FC vehicle 20. The storage unit 22 can store a movement information database 22a, a vehicle information database 22b, and a schedule information database 22c. The movement information database 22a stores various types of data including the movement information related to the position information and the travel route information of the FC vehicle 20, and the movement information provided from the operation management server 10, in an updatable manner. The vehicle information database 22b stores various types of information including the vehicle identification information and the sensor information such as battery SOC and fuel remaining amount in an updatable manner. The schedule information database 22c stores the schedule information for instructing the travel schedule of the FC vehicle 20, which is acquired from the operation management server 10, in an updateable, deletable, and searchable manner.

The communication unit 23 communicates with the operation management server 10 and the user terminal 40 by wireless communication via the network 2. The input/output unit 24 serving as an output unit is configured so that predetermined information can be notified to the outside. The input/output unit 24 serving as an input unit is configured so that a user or the like can input predetermined information to the control unit 21.

The sensor group 25 may have a vehicle speed sensor, an acceleration sensor, a fuel sensor, and other sensors necessary for traveling of the FC vehicle 20, and may further have an imaging unit capable of capturing images of the outside and the inside of the vehicle. The sensor information detected by the various sensors constituting the sensor group 25 is output to the control unit 21 via the vehicle information network (control area network (CAN)) composed of transmission lines connected to the various sensors.

The positioning unit 26 serving as a position information acquisition unit receives radio waves from a global positioning system (GPS) satellite and detects the position of the FC vehicle 20. The detected position is stored in a searchable manner in the movement information database 22a as the position information in the movement information. As a method for detecting the position of the FC vehicle 20, a method combining light detection and ranging or laser imaging detection and ranging (LiDAR) system and a three-dimensional digital map may be adopted. Further, the position information may be included in the movement information, and the position information of the FC vehicle 20 detected by the positioning unit 26 may be stored in the vehicle information database 22b as a part of the vehicle information.

The drive unit 27 is a drive unit for traveling the FC vehicle 20, and includes a transaxle, driven wheels, and drive wheels. The FC vehicle 20 includes a motor as a drive source for driving the drive unit 27. The fuel cell system 28 includes a fuel cell stack, a hydrogen tank, and an air supply unit. The fuel cell system 28 is electrically connected to a drive source motor via a direct current to direct current (DC/DC) converter and an inverter. Thereby, the electric power from the fuel cell system 28 can be supplied to the motor. The fuel cell system 28 is partitioned from the vehicle cabin by a dash panel and housed in an accommodation chamber. The fuel cell system 28 is a power generation device that generates electric energy to drive the drive unit 27 of the FC vehicle 20 by utilizing a chemical reaction between hydrogen supplied from the hydrogen tank and oxygen in the air. The fuel cell system 28 is configured by stacking a plurality of cells, each of which is composed of an electrode composite sandwiched between separators. In the electrode composite, a hydrogen electrode catalyst and an oxygen electrode catalyst are coated on each side of a solid polymer electrolyte membrane.

The storage unit 29 is configured to be capable of storing hot water discharged from the fuel cell system 28. The storage unit 29 is provided with a hot water supply pipe 31 for supplying hot water to the bathtub 30 and a hot water supply faucet 32 capable of discharging hot water. The hot water stored in the storage unit 29 can be supplied to the bathtub 30 through the hot water supply pipe 31. When hot water for drinking or the like is required, hot water can be discharged by opening the hot water supply faucet 32. The storage unit 29 is configured to be able to transfer the heat generated by the fuel cell system 28. Thereby, when the fuel cell system 28 generates heat, the water in the storage unit 29 can be heated. It is also possible to configure the inside of the storage unit 29 so that water can be divided into hot water that is heated and water that is not heated, and that hot water that is heated and water that is not heated can be mixed. Thereby, the temperature of the hot water can be adjusted in the storage unit 29 by the control of the control unit 21.

The control unit 21 in the FC vehicle 20 can also execute a part of the functions of the operation management server 10. That is, the control unit 21 may be configured to be able to execute the functions of the schedule processing unit 111 and the determination unit 112 of the operation management server 10.

User Terminal

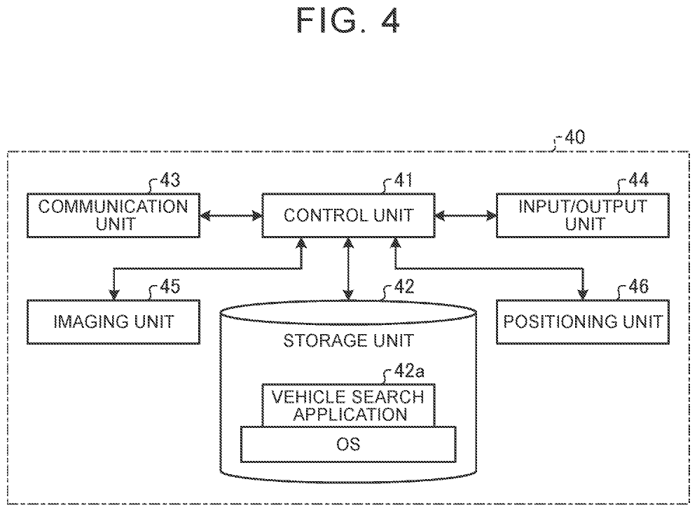

The user terminal 40 serving as a use terminal is operated by users such as a user who drives the FC vehicle 20 or a user who uses the hot water stored in the storage unit 29 of the FC vehicle 20, that is, a user who uses the bathtub 30 or drinks the hot water. The user terminal 40 can transmit various types of information such as user information including user identification information and user selection information to the operation management server 10 by, for example, various programs such as a vehicle search application 42a or a call using voice. The user identification information is identification information for identifying the user terminal 40 and identifying the user who uses the user terminal 40. The user selection information is information that the user has input or selected using the user terminal 40. The user terminal 40 is configured to be able to receive various types of information such as display information from the operation management server 10. FIG. 4 is a block diagram schematically showing a configuration of the user terminal 40.

As shown in FIG. 4, the user terminal 40 includes a control unit 41, a storage unit 42, a communication unit 43, an input/output unit 44, an imaging unit 45, and a positioning unit 46. The control unit 41, the storage unit 42, the communication unit 43, the input/output unit 44, and the positioning unit 46 have the same physical and functional configurations as the control unit 11, the storage unit 12, the communication unit 13, the input/output unit 14, and the positioning unit 26, respectively. The imaging unit 45 is composed of an image sensor such as a complementary metal-oxide semiconductor (CMOS) or a charge-coupled device (CCD) camera and imaging elements, and has a camera function. Here, in the user terminal 40, the call with the outside includes not only a call with another user terminal 40 but also a call with an operator resident in the operation management server 10 or an artificial intelligence system, for example. The input/output unit 44 may be separately configured as an input unit and an output unit. As the user terminal 40, specifically, a mobile phone such as a smartphone, a laptop type or a tablet type information terminal, a laptop type or desktop type personal computer, etc. can be adopted.

The control unit 41 comprehensively controls the operations of the storage unit 42, the communication unit 43, and the input/output unit 44 by executing the OS and various application programs stored in the storage unit 42. The storage unit 42 is configured to be able to store the vehicle search application 42a and the user identification information. The communication unit 43 transmits and receives various types of information such as the user identification information and the user selection information to and from the operation management server 10 and the like via the network 2. The user terminal 40 can be used not only by occupants who get on the FC vehicle 20, but also by users who use the FC vehicle 20 for hot water in the bathtub or foot bath. In this case, by starting the vehicle search application 42a and accessing the operation management server 10, the current position, the destination, the time of arrival at the destination, the staying time, and the like of the FC vehicle 20 desired by the user can be searched.

Operation Management Method

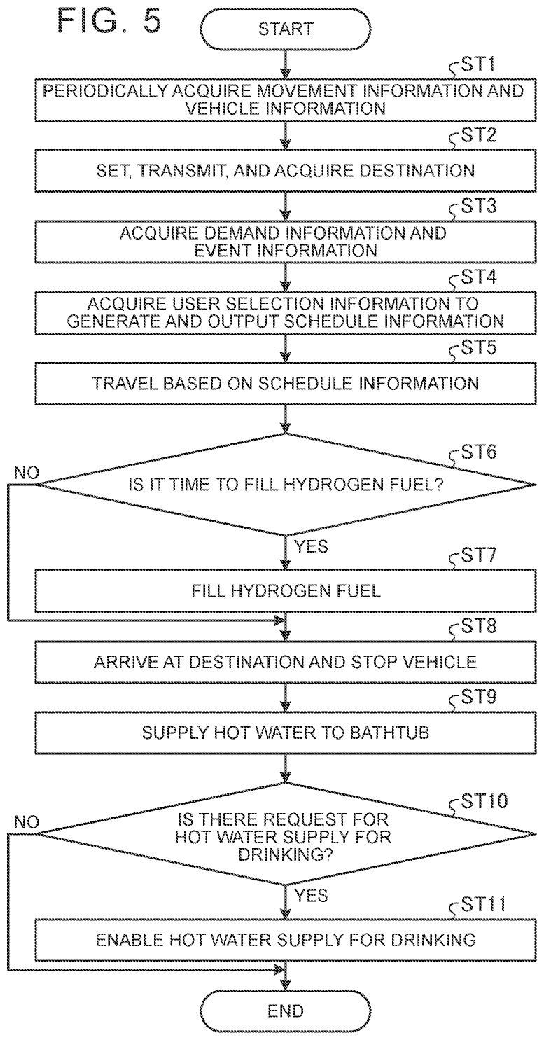

Next, an operation management method according to the present embodiment will be described. FIG. 5 is a flowchart illustrating a management method according to the present embodiment. In the following description, information is transmitted and received via the network 2. However, the description of transmission and reception via the network 2 will be omitted. Further, when information is transmitted and received between the operation management server 10 and the FC vehicle 20 or the user terminal 40, the information is transmitted and received in association with the identification information that identifies each FC vehicle 20 or each user terminal 40. However, the description of transmission and reception of the identification information will be omitted. The flowchart shown in FIG. 5 shows processing for the case where the user uses the bathtub 30 at least once in the operation management system 1, and the flowchart shown in FIG. 5 is executed according to each acquired information of the FC vehicle 20.

As shown in FIG. 5, first, in step ST1, the control unit 11 of the operation management server 10 receives and acquires the movement information and the vehicle information of the FC vehicle 20 at a predetermined timing or periodically. The control unit 11 of the operation management server 10 that has received the movement information and the vehicle information stores the received movement information in the movement management database 12a, and stores the received vehicle information in the vehicle information database 12b.

Next, in step ST2, the user inputs the destination information using the input/output unit 24 of the FC vehicle 20 or the input/output unit 44 of the user terminal 40. The FC vehicle 20 or the user terminal 40 transmits the input destination information as the user selection information to the operation management server 10. The schedule processing unit 111 of the control unit 11 of the operation management server 10 stores the received user selection information in the schedule information database 12c.

Next, in step ST3, the schedule processing unit 111 of the operation management server 10 reads and acquires the demand information and the event information from the event information database 12d. The control unit 11 of the operation management server 10 periodically or appropriately collects the demand information for using the bathtub 30 of the FC vehicle 20 from the user terminal 40. In addition, the control unit 11 periodically or appropriately collects the event information from the user terminal 40 or another server of the business operator that hosts the event. The control unit 11 stores the collected demand information and event information in the event information database 12d.

Next, in step ST4, the schedule processing unit 111 acquires the user selection information including the destination information from the schedule information database 12c, and the movement information including the position information of the current position of the predetermined FC vehicle 20 from the movement management database 12a.

The schedule processing unit 111 derives a travel schedule based on the acquired destination information of the user and the information of the current position of the predetermined FC vehicle 20, and outputs the travel schedule as travel schedule information. The schedule processing unit 111 inputs the information related to the movement of the FC vehicle 20, the information related to the specifications of the fuel cell system 28 and the storage unit 29, and the information on set values of the desired water amount and water temperature as the input parameters in the schedule learning model 12e. The information related to the movement of the FC vehicle 20 is information including the mileage and the travel time from the starting point to the destination. The information on the set values of the desired water amount and water temperature includes the information on the set values of the desired water amount and water temperature of the hot water used at the destination.

The schedule learning model 12e outputs the travel schedule including the travel route on which the FC vehicle 20 travels and the power generation schedule of the fuel cell system 28 as the output parameters. That is, the schedule learning model 12e outputs the schedule information in which the water amount and water temperature of the hot water discharged from the fuel cell system 28 and stored in the storage unit 29 can be set to the set values of the desired water amount and water temperature when the FC vehicle 20 arrives at the destination. A rule-based inference engine may be used instead of the learning model. The travel schedule information includes navigation information such as a route for guiding the traveling of the predetermined FC vehicle 20, a departure time, a scheduled arrival time, and a mileage.

The schedule processing unit 111 derives the power generation schedule of the fuel cell system 28 and the state schedule of the storage unit 29, and outputs the information as power generation schedule information and state schedule information, respectively. The power generation schedule information includes the schedule information of the amount of power generated by the fuel cell system 28, the amount of heat generated, and the remaining amount of hydrogen fuel, and predicted values of the flow rate and the water temperature of the hot water discharged from the fuel cell system 28. The state schedule information includes information of the water storage amount and the water temperature in the storage unit 29, the predicted value of the water storage amount, and the predicted value of the water temperature.

The schedule processing unit 111 may generate the schedule information including the travel schedule information and the state schedule information. In other words, the schedule information may include various types of information on the route on which the FC vehicle 20 is scheduled to travel, various types of information on the power generation of the fuel cell system 28, and prediction information of the water amount and the water temperature in the storage unit 29. The schedule processing unit 111 stores the generated schedule information in the schedule information database 12c, and also transmits the generated schedule information to the FC vehicle 20.

Next, in step ST5, and the control unit 21 of the FC vehicle 20 that has received and acquired the schedule information stores the received schedule information in the schedule information database 22c. The control unit 21 controls the drive unit 27 and the fuel cell system 28 based on the schedule information read from the schedule information database 22c. Thereby, the FC vehicle 20 can travel based on the schedule information. During traveling, the electric power output from the fuel cell system 28 is preferentially used for traveling.

After that, in step ST6, the determination unit 112 of the operation management server 10 determines whether it is time to fill the hydrogen fuel in the travel route during traveling. That is, the determination unit 112 determines whether the free time included in the schedule information has been reached. The free time can be a time zone in which it is less necessary to use the FC vehicle 20 or the bathtub 30. The determination unit 211 of the FC vehicle 20 may execute the determination as to whether the free time included in the schedule information has been reached. When the determination unit 112 or the determination unit 211 determines that it is time to fill the hydrogen fuel (step ST6: Yes), the process proceeds to step ST7, the FC vehicle 20 moves to a hydrogen station, and the hydrogen tank of the fuel cell system 28 of the FC vehicle 20 is filled with hydrogen fuel. The sensor group 25 of the FC vehicle 20 transmits the vehicle information including the sensor information that includes measured values of the filling amount of the hydrogen fuel to the operation management server 10. In contrast, when it is determined that it is not the time to fill the hydrogen fuel (step ST6: No), the traveling is continued and the process proceeds to step ST8.

In step ST8, the FC vehicle 20 arrives at the destination and stops. Here, in the storage unit 29 of the FC vehicle 20, hot water is stored by a water amount equal to or larger than a desired water amount, and the water temperature is also set to a desired water temperature. When the water amount is less than the desired water amount at this point, it is possible to add water loaded in advance. When the water temperature is not as desired, the fuel cell system 28 may be operated to store the generated electric power in the battery, and the obtained heat may be used to heat the water in the storage unit 29.

Subsequently, in step ST9, the control unit 21 of the FC vehicle 20 controls the hot water supply pipe 31 of the storage unit 29 to supply hot water to the bathtub 30. The bathtub 30 may be a bathtub in which humans or animals can take a bath, or a bathtub for so-called foot bath in which only human feet can be immersed.

Next, in step ST10, the determination unit 211 of the control unit 21 determines whether there is a request for hot water supply for drinking. When the determination unit 211 determines that there is a request for hot water supply for drinking (step ST10: Yes), the storage unit 29 is brought to a state that enables the hot water in the storage unit 29 to be supplied to the hot water supply faucet 32, and thus hot water can be supplied as needed. Thereby, the user can obtain the necessary drinking water by opening the hot water supply faucet 32. When the determination unit 211 determines that there is no request for hot water supply of drinking water (step ST10: No), the operation management process according to the present embodiment ends.

Further, when the FC vehicle 20 is a store that provides services such as a so-called public bath where the bathtub 30 can be used for bathing, the determination unit 211 may determine that there is a request for hot water supply for drinking when the opening time of business hours is reached (step ST10: Yes). That is, when the FC vehicle 20 is configured as a store that provides services such as public baths, beverages such as coffee using hot water can be sold as products, so that hot water supply for drinking is likely to be required. In this case, step ST10 can be repeatedly executed while the FC vehicle 20 is stopped. Thereby, the operation management process according to the present embodiment is completed.

According to the embodiment of the present disclosure described above, the FC vehicle 20 is provided with the storage unit 29 capable of storing wastewater discharged from the fuel cell system 28 and the bathtub 30 to which hot water can be supplied from the storage unit 29. Thus, the wastewater from the FC vehicle 20 can be effectively used. Further, by providing the hot water supply faucet 32 capable of supplying hot water from the storage unit 29 to the outside, the wastewater from the FC vehicle 20 can be effectively used as drinking water.

Although the embodiment of the present disclosure has been specifically described above, the present disclosure is not limited to the above-described embodiment, and various modifications based on the technical idea of the present disclosure and embodiments combined with each other can be adopted. For example, the device configurations, display screens, and names given in the above-described embodiment are merely examples, and different device configurations, display screens, and names may be used as necessary.

For example, in the embodiment, deep learning using a neural network is mentioned as an example of machine learning, but machine learning based on other methods may be performed. Other supervised learning such as support vector machines, decision trees, simple Bayes, and k-nearest neighbors may be used. Moreover, semi-supervised learning may be used instead of supervised learning.

Recording Medium

In the embodiment of the present disclosure, a program capable of executing a processing method by the operation management server 10, the FC vehicle 20, and the user terminal 40 can be recorded in a recording medium that is readable by a computer and other machines or devices (hereinafter referred to as “computer or the like”). The computer or the like functions as the control units of the operation management server 10 and the FC vehicle 20 when the computer or the like is caused to read the program stored in the recording medium and execute the program. Here, the recording medium that is readable by the computer or the like means a non-transitory storage medium that accumulates information such as data and programs through an electrical, magnetic, optical, mechanical, or chemical action and from which the computer or the like can read the information. Examples of the recording medium removable from the computer or the like among the recording media described above include, for example, a flexible disc, a magneto-optical disc, a compact disc read-only memory (CD-ROM), a compact disc rewritable (CD-R/W), a digital versatile disc (DVD), a Blu-ray disc (BD), a digital audio tape (DAT), a magnetic tape, and a memory card such as a flash memory. Examples of the recording medium fixed to the computer or the like include a hard disc and a ROM. Further, a solid state drive (SSD) can be used as the recording medium removable from the computer or the like or as the recording medium fixed to the computer or the like.

Other Embodiments

In the operation management server 10, the FC vehicle 20, and the user terminal 40 according to the embodiment, the “unit” can be read as a “circuit” or the like. For example, the communication unit can be read as a communication circuit.

The operation management server 10 or the program to be executed by the operation management server 10 according to the embodiment may be configured to be stored in a computer connected to a network such as the Internet and provided through downloading via the network.

In the description of the flowchart in the present specification, the order of the processing between steps is clarified using expressions such as “first”, “after”, and “subsequently”. However, the order of processing required for realizing the embodiment is not necessarily uniquely defined by those expressions. That is, the order of processing in the flowchart described in the present specification can be changed within a consistent range.

In addition, instead of a system equipped with one server, terminals capable of executing a part of the processing of the server may be distributed and arranged in a place physically close to the information processing device to apply edge computing technology that can efficiently communicate a large amount of data and shorten the arithmetic processing time.

Further effects and modifications can be easily derived by those skilled in the art. The broader aspects of the present disclosure are not limited to the particular details and representative embodiments shown and described above. Accordingly, various modifications can be made without departing from the spirit or scope of the general inventive concept as defined by the appended claims and their equivalents.

What is claimed is:

1. An information processing device, wherein:
the information processing device acquires movement information related to a movement of a moving body from the moving body including a fuel cell using hydrogen fuel as a power source of the moving body, a storage unit for storing hot water discharged from the fuel cell, and a tub for using the hot water discharged from the storage unit;
the information processing device acquires destination information related to a destination of the moving body from the moving body or a terminal of a user who uses the moving body; and
the information processing device includes a processor that acquires set values of a water amount and a water temperature of the hot water stored in the storage unit from the moving body, that generates schedule information related to traveling of the moving body based on the movement information, the destination information, and the set values, and that outputs the schedule information to the moving body.

2. The information processing device according to claim 1, wherein the set values are set values of the water amount and the water temperature of the hot water in a state where the moving body arrives at the destination.

3. The information processing device according to claim 1, wherein the processor collects demand information related to a demand for the hot water and event information from the terminal or a predetermined server, and generates the schedule information based on at least one of the demand information and the event information.

4. The information processing device according to claim 1, wherein the schedule information includes travel schedule information including a travel route and a travel time of the moving body, and power generation schedule information related to power generation by the fuel cell.

5. The information processing device according to claim 1, wherein the moving body moves based on the acquired schedule information.

6. The information processing device according to claim 1, wherein:
the schedule information includes information on a free time other than a time for use of the hot water and for traveling of the moving body; and
the processor sets the free time to a time for filling the fuel cell with the hydrogen fuel.

7. The information processing device according to claim 1, wherein:
the moving body constitutes a store that provides a service using the hot water or that sells a product using the hot water; and
the set values are set values of the water amount and the water temperature of the hot water at an opening time of the store.

8. The information processing device according to claim 7, wherein the hot water from the storage unit is configured to be able to be supplied for drinking.

9. An information processing system, comprising:
a first device including a fuel cell using hydrogen fuel as a power source for movement, a storage unit for storing hot water discharged from the fuel cell, a tub for using the hot water discharged from the storage unit, and a first processor for outputting movement information related to the movement; and
a second device including a second processor that acquires destination information related to a destination of the first device from the first device or a terminal of a user, that acquires set values of a water amount and a water temperature of the hot water stored in the storage unit from the first device, that generates schedule information related to the movement based on the movement information, the destination information, and the set values, and that outputs the schedule information.

10. The information processing system according to claim 9, wherein the set values are set values of the water amount and the water temperature of the hot water in a state where the first device arrives at the destination.

11. The information processing system according to claim 9, wherein the second processor collects demand information related to a demand for the hot water and event information from the terminal or a predetermined server, and generates the schedule information based on at least one of the demand information and the event information.

12. The information processing system according to claim 9, wherein the schedule information includes travel schedule information including a travel route and travel time of the first device, and power generation schedule information related to power generation by the fuel cell.

13. The information processing system according to claim 9, wherein the first device moves based on the acquired schedule information.

14. The information processing system according to claim 9, wherein:
the schedule information includes information on a free time other than a time for use of the hot water and for traveling of the first device; and
the second processor sets the free time to a time for filling the fuel cell with the hydrogen fuel.

15. The information processing system according to claim 9, wherein:
the first device constitutes a store that provides a service using the hot water or that sells a product using the hot water; and
the set values are set values of the water amount and the water temperature of the hot water at an opening time of the store.

16. The information processing system according to claim 15, wherein the hot water from the storage unit is configured to be able to be supplied for drinking.

17. A program that causes a processor to execute:
acquisition of movement information related to a movement of a moving body from the moving body including a fuel cell using hydrogen fuel as a power source of the moving body, a storage unit for storing hot water discharged from the fuel cell, and a tub for using the hot water discharged from the storage unit;
acquisition of destination information related to a destination of the moving body from the moving body or a terminal of a user who uses the moving body;
acquisition of set values of a water amount and a water temperature of the hot water stored in the storage unit from the moving body; and
generation of schedule information related to traveling of the moving body based on the movement information, the destination information, and the set values, and output of the schedule information to the moving body.

18. The program according to claim 17, causing the processor to execute collection of demand information related to a demand for the hot water and event information from the terminal or a predetermined server, and generation of the schedule information based on at least one of the demand information and the event information.

19. The program according to claim 17, wherein:
the schedule information includes information on a free time other than a time for use of the hot water and for traveling of the moving body; and
the program causes the processor to execute setting of the free time to a time for filling the fuel cell with the hydrogen fuel.

20. The program according to claim 17, wherein the schedule information includes travel schedule information including a travel route and travel time of the moving body, and power generation schedule information related to power generation by the fuel cell.
